(19) United States
(12) Patent Application Publication
(10) Pub. No.: US 2026/0094356 A1
(43) Pub. Date: Apr. 2, 2026

(54) RENDERING SYSTEM FOR POST-CONSTRUCTION VISUALIZATION OF ELECTRIC VEHICLE SUPPLY EQUIPMENT

(71) Applicant: Coulomb Technologies dba AlphaGrid, Palo Alto, CA (US)

(72) Inventors: Phillip Ellsworth STAHLFELD, Mountain View, CA (US); Lucas Michael ACKERKNECHT, San Francisco, CA (US); Kshitij Naresh NIKHAL, San Jose, CA (US)

(21) Appl. No.: 18/902,801

(22) Filed: Sep. 30, 2024

(51) Int. Cl. G06T 15/20; G06N 3/0455; G06Q 50/08; G06V 10/82; G06V 20/52; H04W 4/029

(52) U.S. Cl. CPC G06T 15/205; G06N 3/0455; G06Q 50/08; G06V 10/82; G06V 20/52; H04W 4/029

(57) ABSTRACT

The disclosed technology includes techniques for generating realistic, true-to-scale renderings of electric vehicle (EV) chargers in parking areas, which can facilitate the planning and deployment of EV infrastructure to mitigate climate change. The method involves obtaining overhead and ground-level images of the parking area along with location data for the intended EV charger. A first machine learning (ML) model processes these inputs to create an intermediate image, which is then refined by a second ML model to produce a final render image that realistically depicts the EV charger within the parking area. A third ML model then evaluates the final render image and uses a feedback loop to improve the quality of future renderings. The system can also incorporate geolocation data, images of scenery, and text-based prompts to enhance the renderings, thereby promoting the adoption of EVs and reducing greenhouse gas emissions.

### BACKGROUND

The rapid growth of electric vehicles (EVs) has significantly increased the demand for EV charging stations. As more consumers and businesses transition to electric mobility, the need for accessible and efficient charging infrastructure has become significant. For businesses, hosting an EV charging station can attract EV users and enhance the appeal to customers. However, despite the advantages of hosting EV charging stations, investing in such infrastructure presents several challenges, such as high initial capital costs, complex regulatory requirements, and the need for strategic site selection to ensure optimal usage. The difficulty involved in site selection includes both the practical requirements of choosing viable locations to host the charging station and accompanying equipment, as well as the aesthetic requirements specific to the business's location.

Obtaining detailed plans to overcome these challenges can be influential on the decision to invest in an EV charging station. An accurate and attractive representation of the final results of a construction project can persuade and reassure stakeholders. Furthermore, these representations can help with acquiring local permits that are required to install the equipment. Often, an image or three-dimensional representation of the final results would be created by a graphic designer or architectural designer. These renderings can be cost-prohibitive and cannot easily be adapted if the intended location of the EV charging station is later changed.

### BRIEF DESCRIPTION OF THE DRAWINGS

FIGS. 1A-1B are illustrations depicting the parking site before the installation of proposed electric vehicle supply equipment (EVSE).

FIG. 2 is a block diagram of an automated workflow incorporating AI models that can implement aspects of the present technology.

FIG. 3 is an illustration depicting EVSE graphics which are to be incorporated into the image of the parking site.

FIG. 4 is an illustration depicting the parking site of FIG. 1 after the installation of EVSE.

FIG. 5 is a flowchart of a method for modifying an image of a site to incorporate EVSE at specified locations.

FIG. 6 is a block diagram of an AI machine learning model such as those on which at least some operations described herein can be implemented.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology describes an automated system for rendering true-to-scale, lifelike images of post-construction electric vehicle (EV) charging infrastructure within a given parking area. This system leverages generative AI to create vertical (panoramic) images of a given location, which are based on a site layout (such as provided by aerial imagery) and a reference panoramic image of the location taken at ground level. The site layout is used as a reference by the user to provide the intended locations for Electric Vehicle Supply Equipment (EVSE) components such as EV chargers and power cabinets.

These images are accepted by a generative AI pre-processing model to create a “clean” render of the site. This model refines the reference panoramic image, for instance by removing elements that obstruct the view of the parking lot or removing blemishes such as debris from the image. This clean render is then used as the input of a rendering generative AI model. This model has access to databases containing reference images of EVSE and vehicles. This model creates a final render of how the site would look soon after the installation of the EVSE.

The final render is then used as the input of a filtering AI model. This filtering model has access to a natural image database that stores images of parking areas after the installation of EVSE. The filtering model assesses the final render by comparing it to the reference images in the natural image database and quantifies this comparison in various metrics that are then used to improve the rendering generative model. This feedback loop of creating final renders and then assessing those renders by using real-world data allows the rendering generative model to continuously improve while in use.

The disclosed technology contributes to mitigating climate change by streamlining the deployment of EV charging infrastructure. By leveraging generative AI to create accurate, true-to-scale images of post-construction EV charging sites, the system facilitates quicker and more efficient planning and installation of EV chargers. By allowing stakeholders to visualize and optimize the placement of EVSE components, this technology reduces the hurdles to installing EVSE and facilitates the widespread implementation of EV charging infrastructure. As a result, the adoption of EVs is accelerated, reducing reliance on fossil fuels and lowering greenhouse gas emissions. By making the planning and installation process more efficient, this technology plays a significant role in promoting sustainable transportation solutions and combating climate change.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

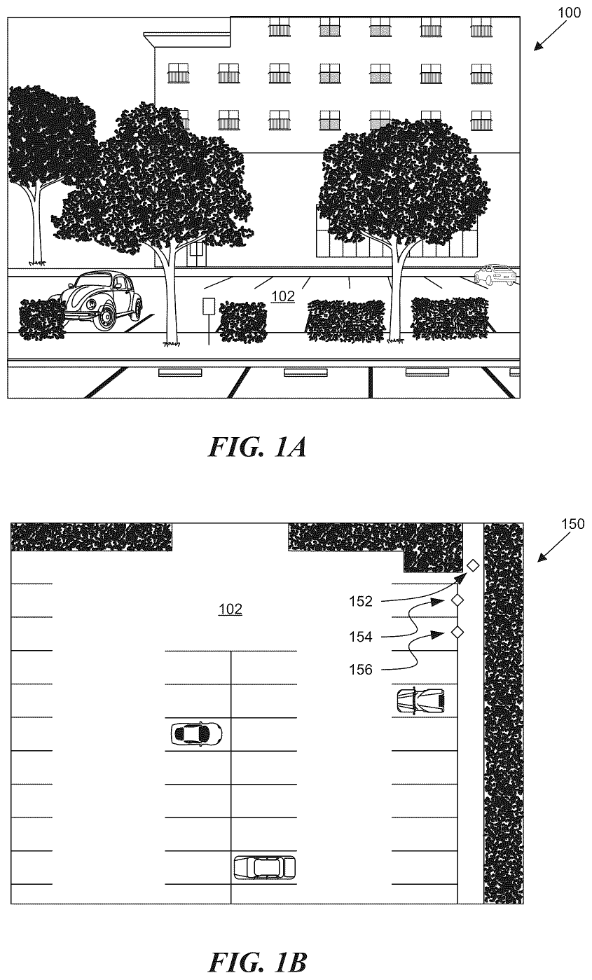

FIGS. 1A-1B depict images of a parking area 102. FIG. 1A depicts a ground-level “vertical” or panorama image 100 of the parking lot from a perspective near ground level. Such parking areas can include, but are not limited to, parking lots, on-street parking spaces, single parking spaces, residential driveways, or multi-level parking structures. The image 100 is intended to represent the desired point of view of the final rendered image. The image 100 can come from a variety of sources, such as a photograph taken by a user, or from an image service such as Google Street View. Such images can also have associated image and camera metadata, such as geolocation information comprising the location the image was taken from and the heading and orientation of the camera that took the image. The image itself can be of any size or orientation, including portrait, landscape, or panorama images, and does not necessarily need to be a photograph. The ideal image would include the proposed locations of all EVSE components as well as the surrounding environment.

FIG. 1B depicts an aerial or overhead image 150 of the parking area 102. This is one example of a site layout image that can be used by the present technology. The site layout can come from a variety of sources, such as an aerial photograph taken as part of a survey, drafted architectural plans, or a photograph from an aerial image service such as Google Maps. Such images can also have associated image and camera metadata, such as geolocation information comprising the geographic position (such as latitude, longitude, and altitude) corresponding to each pixel of the image.

The intended locations and types of the EVSE components are marked by the user onto the overhead image 150. In one embodiment, the user is prompted with a user interface (UI) in which they can choose various types of EVSE components such as EV chargers, informational signage, and power cabinets, and place corresponding markers 152, 154, 156 directly onto the aerial image. This location data and type data is then processed alongside the original overhead image. In another embodiment, the overhead image 150 is modified directly to include markers 152, 154, 156 indicating the position and type of the EVSE component, for instance, through color coding the markers to correspond with the different EVSE component types. This location data may also include the direction of the EVSE components.

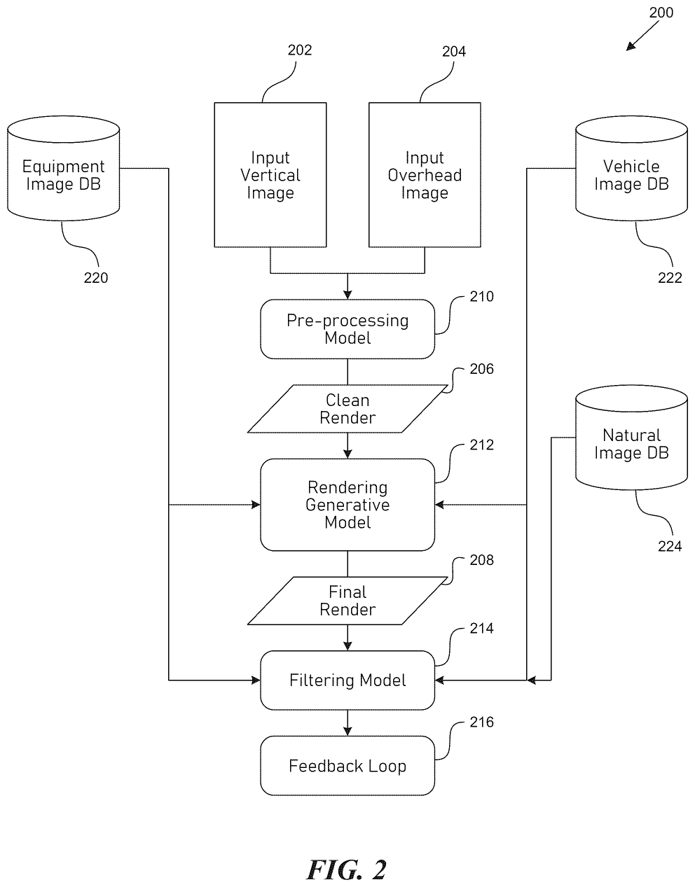

FIG. 2 is a block diagram 200 depicting one embodiment of the present technology. A user selects input data, including a ground-level “vertical” or panorama image 202 and an aerial or overhead image 204. The vertical image 202 corresponds to the intended perspective of the final render image 208. This image can be supplied by the user if it is an image in their possession (e.g., saved to their desktop), or the user can select an image from a public image source, such as Google Street View. The overhead image 204 gives a clear indication of the layout of the parking area and assists in determining correct distances between objects depicted in the vertical image 202. This image can be supplied by the user if it is an image in their possession, or the user can select an image from a public image source, such as Google Maps. In this embodiment, the overhead image 204 has been modified to include the intended location of the EVSE components.

The vertical image 202 and the overhead image 204 are then processed by a pre-processing machine learning (ML) model 210. The pre-processing model 210 modifies the vertical image 202, by performing such actions as: removing debris from the image; removing objects that may be occluding the view of the parking area, such as vehicles or pedestrians; removing defects such as worn paint or cracks in the pavement; and correcting the perspective by causing a rotation of the image. The goals that are emphasized by the model include: providing an unobstructed view of the parking area, particularly the intended locations of the EVSE components; ensuring minimal alterations to the content of the parking area will be necessitated by the introduction of the EVSE components; and adjusting viewing parameters, such as yaw, roll, pitch, and standoff distance, to achieve an accurate representation of the parking area and a view that is consistent with the representations of the EVSE components. Furthermore, the model preserves various characteristics of the surrounding environment, such as buildings, parking layout, and vegetation. To accomplish this, the pre-processing model may have access to relevant reference images (such as trees, fences, sidewalks, and other relevant scenery items) or it may have been trained on such data relevant to this task. This process creates as output an intermediate “clean” image render 206 that is a modified version of the vertical image 202. Creating this intermediate image is intended to improve the performance of further processing of the image by, for instance, allowing those further processes to specialize in embedding the representations of EVSE.

The clean render 206 becomes the input of a rendering generative model 212. The goal of this model is to embed accurate representations of EVSE components into the clean image while modifying as little as possible. The rendering generative model 212 processes the clean render 206, the overhead image 204 including the intended locations of the EVSE components, images of EVSE from an EVSE image database 220, and images of vehicles from a vehicle image database 222. The EVSE image database 220 contains images of EVSE components and can also contain data associated with each image such as the component type, brand, color, and the dimensions of the component. The vehicle image database 222 contains images of vehicles and can also contain data associated with each image such as the vehicle type, make, model, color, and the dimensions of the vehicle. In some embodiments, these images and data may instead be directly supplied by a user rather than a database. In other embodiments, the model is trained using these images and associated data as training data and the model does not need to process such images and associated data as part of its operation.

The rendering generative model 212 then generates as output a final render image 208, which is a modified version of the clean render 206 and thus a modified version of the vertical image 202. This render is a realistic depiction of the parking area 102 with the inclusion of the EVSE components in the locations indicated by the user at markers 152, 154, 156. The final render image is generated to realistically depict the EVSE components'relative size, shape, and perspective in a physically plausible way within the image, but can embody distinct stylized aesthetic forms, such as photorealism, watercolor, line art, appearing as a 3D render, or other such presentations. In some embodiments, the rendering generative model 212 also processes textual input by the user and considers this text when generating the final result. This text could influence environmental aspects of the final render such as weather, style, and time of day, and could further influence aspects such as the type and number of vehicles included. This final render image is then presented to the user.

The final render image 208 is then processed by a filtering model 214. This filtering model assesses the quality and realism of the image. It calculates metrics that evaluate such qualities as: if the parking area has accurately taken into account the space restrictions associated with the EVSE locations, if the EVSE representations accurately reflect the corresponding images in the EVSE database, if the parking area is self-consistent (such as having equally sized parking spaces), and the overall aesthetic appearance of the image. To assess the quality of the representations of EVSE and vehicles in the final render image 208, the filtering model 214 has access to the equipment image database 220 and the vehicle image database 222. The model can then evaluate such characteristics as the consistency in perspective between the representations of the EVSE and/or the vehicles with the surrounding environment, and whether the representations of the EVSE and/or vehicles closely match the reference images they correspond to. To assess how realistic the final render image 208 is, the filtering model 214 has access to a natural image database 224. This database contains images of real parking areas in which EVSE have been installed. Objective metrics such as Kullback-Leibler divergence or Maximum Mean Discrepancy can be used to quantify the comparison of the final render image with images of real parking areas. Such metrics may be predetermined to be used by the model or chosen automatically by the model 214 or as part of the feedback loop 216. In other embodiments, the filtering model 214 is trained using images such that the images in the natural image database do not need to be separately supplied and processed by the model as part of its operation.

The output of the filtering model 214 includes data that can be used to improve the rendering generative model 212, the pre-processing model 210, or both. Such improvements can include but are not limited to: updating the weights of a model, modifying model hyperparameters such as the number of layers and the layer types, and deciding that a certain image should become part of a model's training data for future training. This information is used as part of a feedback loop 216, where it is used to improve the output of one or more models. This feedback loop 216 can incorporate the techniques of online (or continuous) training to keep the models accurate over time, such as identifying data drift by calculating the Jensen-Shannon divergence. These techniques allow the embodiment shown in block diagram 200 to improve over time without supervision while in use.

Several ML models can be employed to comprise the function of each of the models 210, 212, 214. An ML model can further include multiple ML models that are trained independently or trained together as a single effective model. Convolutional Neural Networks (CNNs) are specifically designed to process pixel data, utilizing layers of convolutional filters to detect and learn various features within the images, such as edges, textures, and patterns. These learned features are then used to generate modified versions of the input images, ensuring that the modifications are contextually relevant and visually coherent. Generative Adversarial Networks (GANs) consist of two neural networks, a generator and a discriminator, that are trained simultaneously through adversarial processes. The generator creates modified images, while the discriminator evaluates their authenticity compared to real images, enabling the generator to produce realistic and sophisticated modifications.

Autoencoders, including Variational Autoencoders (VAEs), compress input images into latent representations and then reconstruct them, allowing for various modifications to be applied in the latent space. VAEs introduce a probabilistic approach to encoding, which facilitates the generation of diverse and novel image variations. Advanced optimization techniques, such as Adam and RMSprop, are essential for efficiently training these complex models, adjusting the learning rates dynamically to ensure faster convergence and improved stability. Support Vector Machines (SVMs) are a powerful tool for classification and regression tasks in machine learning. SVMs optimize a hyperplane intended to separate data points of different classes with the maximum margin. This margin maximization ensures that the model generalizes well to unseen data, making SVMs effective for tasks such as image classification and object detection.

Diffusion models are commonly used for image processing and modification. These models iteratively denoise images, starting from random noise and progressively refining the image to achieve the desired output. The iterative denoising process can be guided by user-provided text-based prompts, user-provided masks, or autonomously created soft spatial masks, allowing for precise and contextually relevant modifications. Such masks constrain the modifications to specific areas of the input image. A “hard” spatial mask forces all modifications to occur on a subset of pixels defined by the mask, while a “soft” mask allows more flexibility in where the modifications occur while still focusing the modifications into certain areas of the image. By leveraging these guided denoising techniques, diffusion models can produce high-quality, visually coherent images that align with user specifications and creative intent.

A large vision-language model (VLM) integrates computer vision (CV) and natural language processing (NLP) to perform tasks using multimodal understanding. VLMs are designed to understand and generate responses that are coherent across both image and text modalities and tend to focus on understanding and interpreting correlations between textual and image data. This typically involves the use of multi-modal transformers or similar architectures that can handle different types of data simultaneously. A common implementation involves an image encoder, an embedding projector (such as a dense neural network) to align image and text representations, and a text decoder, though other implementations exist. This integrated approach allows the model to leverage the complementary information present in visual and textual inputs. These models are generally trained on data that involves images with associated text and can be used in a variety of tasks such as automatic image captioning, text-guided image generation and modification, and visual question answering. They may also be designed to output information about an image such as identifying entities within an image or answering questions about entities'absolute or relative positions. Transfer Learning can be leveraged to expedite the training process and improve model accuracy. By utilizing pre-trained models on large datasets, the machine learning model can inherit learned features and patterns, which can then be fine-tuned for specific image modification tasks. Transfer Learning is particularly beneficial when the available dataset is small or lacks diversity. Fine-tuning pre-trained models allows for the adaptation of generic features to specific tasks, improving the overall performance and efficiency of the image generation model.

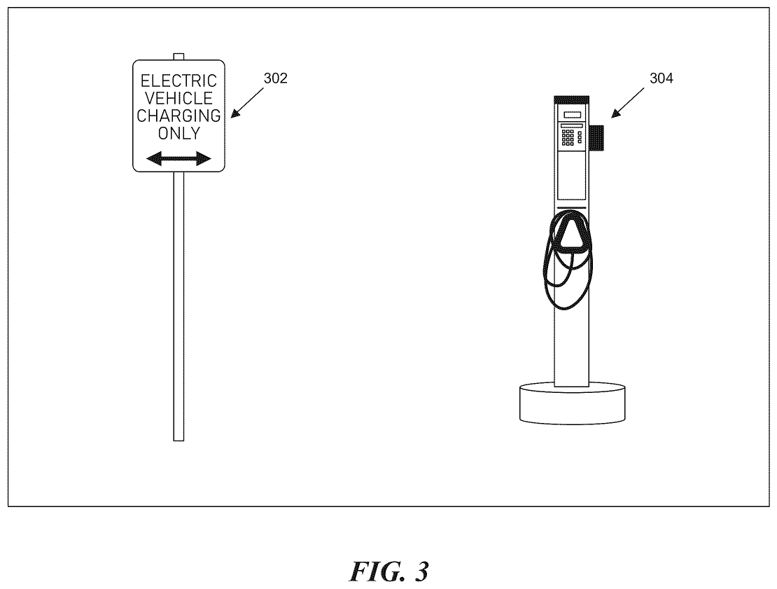

FIG. 3 depicts images of electric vehicle charging equipment (EVSE) components that may be included in the equipment image database 220. Image 302 is a representation of signage related to an electric vehicle charging station, and image 304 is a representation of an electric vehicle charger. Images in the equipment image database 220 can be saved in image formats such as PNG, JPEG, in a vector graphics format such as SVG, or any other suitable image format. The images have descriptive information associated with them, such as text present on signage, the brand or type of component in the image, the color of the component, and the dimensions of the component. The database 220 can include multiple angles of each component to facilitate realistically embedding the components into the final render.

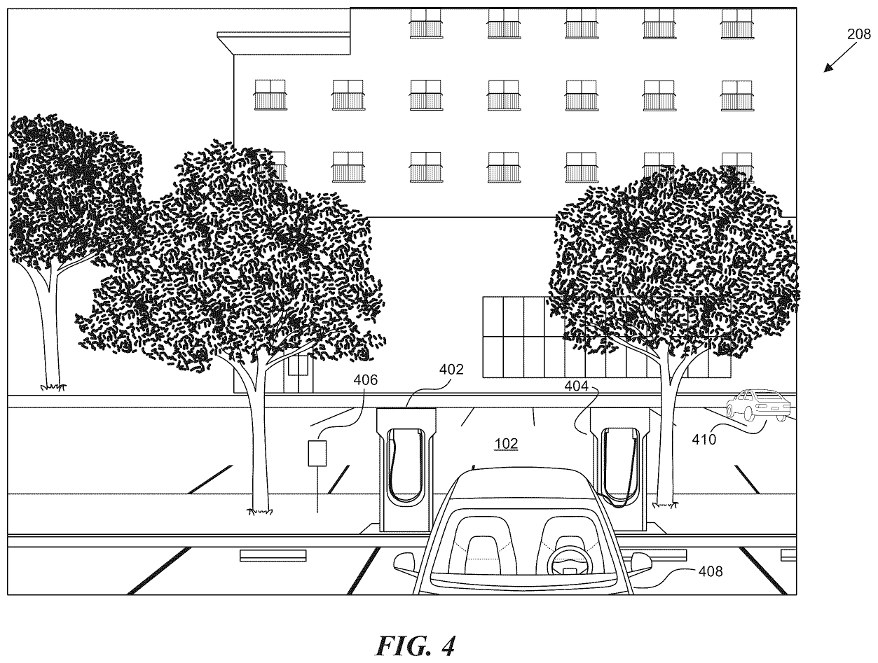

FIG. 4 depicts an intended final render image 208, including representations 402, 404, 406 of EVSE components and representations 408, 410 of vehicles that have been realistically embedded into the clean render 206 comprising a representation of the parking area 102.

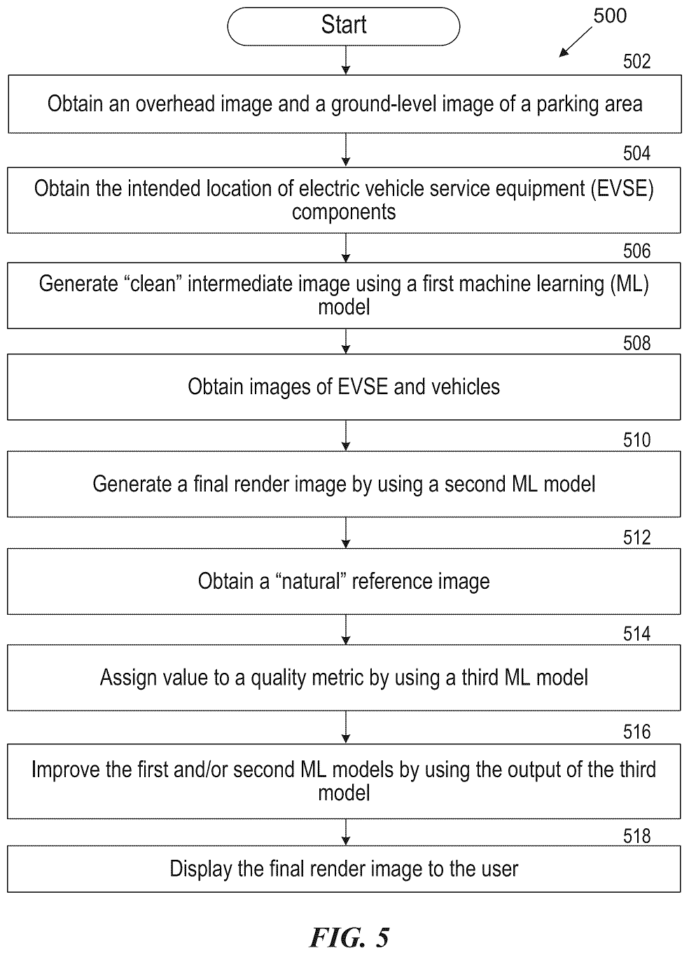

FIG. 5 is a flowchart of a method 500 for modifying an image of a site to incorporate EVSE at specified locations. The method can be performed by a computer system comprising a non-transitory, machine-readable storage medium with instructions recorded thereon, a processor that can execute these instructions, a means of accepting input from a user, and a means of displaying visual information to a user.

At 502, the system obtains a set of images of a parking area. The set of images includes an overhead image taken from an overhead perspective of the parking area and a ground-level image taken from a perspective at or near ground level. In some examples, geolocation data may be associated with one or more images. This geolocation data can take the form of camera metadata and include the location and orientation of the camera that created the image. This can allow each pixel in the images to be linked to the specific geographic position that is represented by the pixel.

At 504, the system obtains location data corresponding to an intended location of an EVSE component, such as an EV charger within the parking area. The location data corresponds to a location shown in the overhead image of the parking area. In some implementations, a user supplies this location data through a user interface by selecting a region of the overhead image. This location data can include one or more locations corresponding to one or more EVSE of various types. In another implementation, the overhead image is modified to include an indication of the intended location of an EVSE. For example, the image can be modified to include a marker that will be recognized by the system as an intended location. These markers can further be differentiated by shape and/or color to designate different types of EVSE that are to be included.

At 506, the system generates an intermediate or “clean” image by using a first ML model. The first model processes the set of images of 502 and the location data of 504. The first model may further process a text-based input from the user to influence the content of the intermediate image. The intermediate image is a modified version of the ground-level image of the parking area. The intermediate image is configured to improve the output of a second ML model. It can do this, for instance, by removing debris and occluding objects or by correcting perspective. Any model of method 500 can comprise various ML model architectures, including but not limited to a diffusion model, a CNN, a GAN, a variational autoencoder (VAE), an SVM, a large language model (LLM), or a large vision-language model (VLM). Furthermore, any model of method 500 may also be a combination of one or more such models.

At 508, the system obtains images of EVSE and of vehicles. These can be obtained in a number of ways, such as being supplied by the user or obtained from an image database. These images may also have associated data, such as model, brand, color, and the physical dimensions of the object. The user may select properties of the included EVSE (e.g., brand, color, type), and similarly the user may select properties of the included vehicles (e.g., make, model, color, number, orientation). The user's selection may influence the images that are processed by the model (e.g., the model only processes the selected images) or may influence the image representations that are embedded into the final render image (e.g., only the selected images have representations that are embedded into the final render image).

At 510, the system generates a final render image by using a second machine learning model. The final render image is a modified version of the ground-level image and is a realistic depiction of the parking area in the ground-level image that incorporates EVSE. The final render image includes image representations of EVSE and can further include image representations of vehicles. If at 502, the system obtained geolocation information pertaining to the ground-level and/or overhead images, the second model can process this data. This information can be used to accurately determine the distance from the image's viewpoint to elements in the image. This can be used to create representations of EVSE and/or vehicles that have the correct size and orientation relative to the viewpoint. If the images of EVSE and vehicles obtained in 508 include physical dimensions, this can also be used to accurately scale and orient the image representations. The second model may further process text-based input from the user to influence the content of final render image, for instance, by affecting the light level, time of day, weather, and other qualities of the final render image. It can then generate the final render image based in part on the user-supplied text-based prompt.

At 512, the system obtains at least one “natural” reference image of a parking area in which at least one EVSE component has been installed. Such natural images may also contain vehicles and other scenery elements that the final render image is expected to include. These reference images can be obtained in a number of ways, such as being supplied by a user or obtained from a natural image database.

At 514, the final render image is processed by a third ML model. This model assesses the accuracy and realism of the final render image. It does this by comparing the final render image to the reference images of 512. The third model quantifies a quality of the image (e.g., realism) by assigning a value to a predetermined metric.

At 516, the system uses the output of the third model (such as the value assigned to the predetermined metric) as part of a feedback loop to improve the other models of the system, either the first ML model, the second ML model, or both.

At 518, the system displays the results to a user.

### Computer System

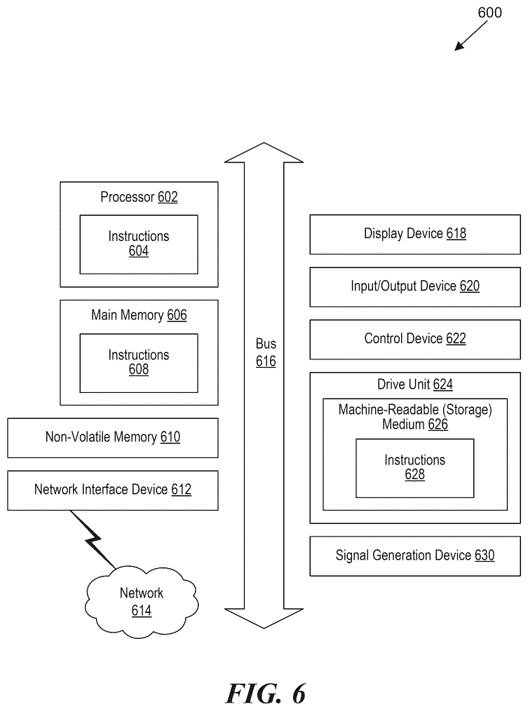

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Machine Learning Models

To assist in understanding the present disclosure, some concepts relevant to neural networks and machine learning (ML) are discussed herein. In the present disclosure, the term “ML-based model” or more simply “ML model” or “model” may be understood to refer to an algorithm that is trained to complete a certain task or model a certain target behavior. Training an ML model refers to a process of learning the values of certain parameters such that the ML model is able to model the target behavior to a desired degree of accuracy. Training typically requires the use of a training dataset, which is a set of data that is relevant to the target behavior of the ML model.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here. Training a neural network model involves learning the values of the parameters (i.e., the weights) of the neurons in the layers such that the neural network model is able to model the target behavior to a desired degree of accuracy.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. DNNs are often used as ML-based models for modeling complex behaviors (e.g., human language, image recognition, object classification) in order to improve the accuracy of outputs (e.g., more accurate predictions) such as, for example, as compared with models with fewer layers.

Generative ML models or simply “generative models” are distinguished by their ability to create new, synthetic data that closely resembles the training data. Unlike discriminative models, which focus on predicting labels for given inputs, generative models learn the underlying distribution of the data, enabling them to generate entirely new instances. This makes them particularly valuable for applications requiring data augmentation, creative content generation, and simulation. Key examples of generative models include Generative Adversarial Networks (GANs) and Variational Autoencoders (VAEs). GANs operate through a dynamic interplay between a generator, which creates data, and a discriminator, which evaluates its authenticity. VAEs, in contrast, encode data into a latent space and then decode it to produce new samples. The training of generative models involves optimizing their parameters to enhance the realism and diversity of the generated outputs, thereby expanding the potential for innovation in various fields.

As an example, to train an ML model that is intended to model human language (also referred to as a language model), the training dataset may be a collection of text documents referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

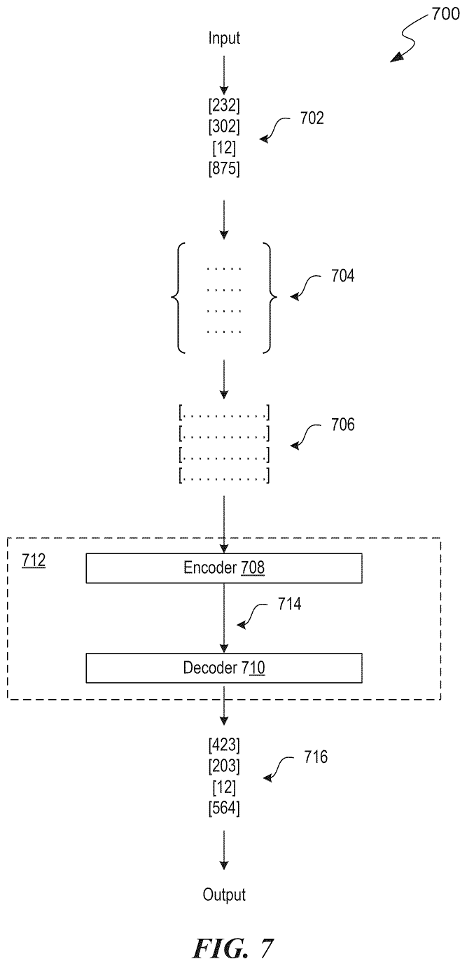

FIG. 7 is a block diagram 700 of an example transformer 712. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 712 includes an encoder 708 (which can comprise one or more encoder layers/blocks connected in series) and a decoder 710 (which can comprise one or more decoder layers/blocks connected in series). Generally, the encoder 708 and the decoder 710 each include a plurality of neural network layers, at least one of which can be a self-attention layer. The parameters of the neural network layers can be referred to as the parameters of the language model.

The transformer 712 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 712 is trained to perform certain functions on other input formats than natural language input. For example, the input can include objects, images, audio content, or video content, or a combination thereof.

The transformer 712 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 7 illustrates an example of how the transformer 712 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 7, a short sequence of tokens 702 corresponding to the input text is illustrated as input to the transformer 712. Tokenization of the text sequence into the tokens 702 can be performed by some pre-processing tokenization module such as, for example, a byte-pair encoding tokenizer (the “pre” referring to the tokenization occurring prior to the processing of the tokenized input by the LLM), which is not shown in FIG. 7 for simplicity. In general, the token sequence that is inputted to the transformer 712 can be of any length up to a maximum length defined based on the dimensions of the transformer 712. Each token 702 in the token sequence is converted into an embedding vector 706 (also referred to simply as an embedding 706). An embedding 706 is a learned numerical representation (such as, for example, a vector) of a token that captures some semantic meaning of the text segment represented by the token 702. The embedding 706 represents the text segment corresponding to the token 702 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 706 corresponding to the “write” token will be closer to another embedding corresponding to the “jot down” token in the vector space as compared to the distance between the embedding 706 corresponding to the “write” token and another embedding corresponding to the “summary”token.

The vector space can be defined by the dimensions and values of the embedding vectors. Various techniques can be used to convert a token 702 to an embedding 706. For example, another trained ML model can be used to convert the token 702 into an embedding 706. In particular, another trained ML model can be used to convert the token 702 into an embedding 706 in a way that encodes additional information into the embedding 706 (e.g., a trained ML model can encode positional information about the position of the token 702 in the text sequence into the embedding 706). In some examples, the numerical value of the token 702 can be used to look up the corresponding embedding in an embedding matrix 704 (which can be learned during training of the transformer 712).

The generated embeddings 706 are input into the encoder 708. The encoder 708 serves to encode the embeddings 706 into feature vectors 714 that represent the latent features of the embeddings 706. The encoder 708 can encode positional information (i.e., information about the sequence of the input) in the feature vectors 714. The feature vectors 714 can have very high dimensionality (e.g., on the order of thousands or tens of thousands), with each element in a feature vector 714 corresponding to a respective feature. The numerical weight of each element in a feature vector 714 represents the importance of the corresponding feature. The space of all possible feature vectors 714 that can be generated by the encoder 708 can be referred to as the latent space or feature space.

Conceptually, the decoder 710 is designed to map the features represented by the feature vectors 714 into meaningful output, which can depend on the task that was assigned to the transformer 712. For example, if the transformer 712 is used for a translation task, the decoder 710 can map the feature vectors 714 into text output in a target language different from the language of the original tokens 702. Generally, in a generative language model, the decoder 710 serves to decode the feature vectors 714 into a sequence of tokens. The decoder 710 can generate output tokens 716 one by one. Each output token 716 can be fed back as input to the decoder 710 in order to generate the next output token 716. By feeding back the generated output and applying self-attention, the decoder 710 is able to generate a sequence of output tokens 716 that has sequential meaning (e.g., the resulting output text sequence is understandable as a sentence and obeys grammatical rules). The decoder 710 can generate output tokens 716 until a special [EOT] token (indicating the end of the text) is generated. The resulting sequence of output tokens 716 can then be converted to a text sequence in post-processing. For example, each output token 716 can be an integer number that corresponds to a vocabulary index. By looking up the text segment using the vocabulary index, the text segment corresponding to each output token 716 can be retrieved, the text segments can be concatenated together, and the final output text sequence can be obtained.

In some examples, the input provided to the transformer 712 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia? ”and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

To enhance the models in the invention to better factor in climate change and produce results that mitigate its potential impact, the system could integrate environmental impact data and sustainability metrics into the generative AI models. This improvement could involve several key steps. First, relevant data can be obtained such as EV utilization statistics and environmental data on local climate conditions, air quality, and carbon footprint. These data can then be incorporated into the AI models. By factoring in these variables, the models can optimize the type and placement of EV charging infrastructure to maximize environmental benefits. Additionally, these metrics could assess factors such as energy efficiency, potential for renewable energy integration (e.g., solar panels), and the reduction in greenhouse gas emissions. The models can use these metrics to prioritize configurations that offer the highest environmental benefits.

Furthermore, the models could be configured to suggest the incorporation of green infrastructure elements, such as permeable pavements, green roofs, and vegetation, which can help manage stormwater, reduce heat islands, and improve air quality. The models can generate images that not only show the EV chargers but also visualize these sustainable features, promoting a holistic approach to climate change mitigation. A life cycle analysis component could be implemented within the system to evaluate the long-term environmental impact of the EVSE installations. This analysis can consider the entire lifecycle of the infrastructure, from manufacturing and installation to maintenance and eventual decommissioning, ensuring that the chosen configurations are sustainable over their entire lifespan. Finally, users and community stakeholders could provide feedback on the environmental impact of proposed EVSE installations. This feedback can be used to continuously refine the models, ensuring that they align with local sustainability goals and community preferences. By integrating these enhancements, the generative AI models can produce images and configurations that not only facilitate the deployment of EV charging infrastructure but also actively contribute to climate change mitigation.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to. ” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for. ” However, the use of the term “for” in any other context is not intended to invoke a similar interpretation. The applicant reserves the right to pursue such additional claim forms either in this application or in a continuing application.

I/We claim:

1. A computer-implemented method comprising:
obtaining a set of images of a parking area, the set of images comprising:
an overhead image taken from an overhead perspective of the parking area, and
a ground-level image taken from a perspective at or near ground level;
obtaining location data corresponding to an intended location of an electric vehicle (EV) charger within the parking area,
wherein the location data corresponds to a location on the overhead image of the parking area;
generating an intermediate image by using a first machine learning (ML) model,
wherein the first ML model processes the location data and the set of images of the parking area,
wherein the intermediate image is a modified version of the ground-level image and is configured to improve an output of a second ML model;
generating a final render image by using the second ML model,
wherein the second ML model processes the location data, the set of images of the parking area, and the intermediate image,
wherein the final render image is a version of the ground-level image, modified to be a realistic depiction of the EV charger incorporated into the parking area shown in the ground-level image; and
causing a computing device to display the final render image.

2. The method of claim 1, further comprising:
obtaining geolocation data for the overhead and ground-level images in the set of images of the parking area,
wherein the geolocation data comprises camera metadata, including location and orientation information, allowing each pixel in each of the overhead and ground-level images to be linked to a specific geographic position;
determining, based on the geolocation data, a size and orientation for a representation of the EV charger to be included in the final render image;
generating an image of the EV charger that has the determined size and orientation; and
causing the final render image to include the image of the EV charger having the determined size and orientation.

3. The method of claim 1, further comprising:
incorporating environmental impact data and sustainability metrics into the generation of the final render image,
wherein the environmental impact data and sustainability metrics relate to reducing emissions of greenhouse gasses and are used for a type and/or a placement of an EV charger to mitigate climate change;
obtaining images of EV chargers; and
processing the images of EV chargers with the second ML model,
wherein the second ML model embeds an image of an EV charger into the final render image.

4. The method of claim 3, further comprising:
receiving, from a user, a selection of the images of EV chargers that are processed by the second ML model.

5. The method of claim 1, wherein the second ML model comprises:
a diffusion model,
a convolutional neural network (CNN),
a generative adversarial network (GAN),
a variational autoencoder (VAE),
a vision-language model (VLM), or
a support vector machine (SVM).

6. The method of claim 1, further comprising:
processing, with a third ML model, the final render image and an image of a parking area in which an EV charger has been installed;
quantifying a quality of the final render image by assigning a value to a predetermined metric; and
improving the second ML model based on the value assigned to the predetermined metric.

7. The method of claim 1, further comprising:
obtaining, from a user, a text-based prompt;
processing the text-based prompt by the second ML model; and
causing the generation of the final render image by the second ML model based on the text-based prompt.

8. A system comprising:
at least one hardware processor; and
at least one non-transitory memory storing instructions, which, when executed by the at least one hardware processor, cause the system to:
obtain a set of images of a parking area, the set of images comprising:
an overhead image taken from an overhead perspective of the parking area, and
a ground-level image taken from a perspective at or near ground level;
obtain location data corresponding to an intended location of electric vehicle service equipment (EVSE) within the parking area,
wherein the location data corresponds to a location on the overhead image of the parking area;
generate an intermediate image by using a first machine learning (ML) model,
wherein the first ML model processes the overhead image and the ground-level image; and
generate a final render image of the parking area by using a second ML model,
wherein the second ML model processes the location data, the overhead image, the ground-level image, and the intermediate image, and
wherein the final render image is a depiction of the EVSE incorporated into the parking area shown in the ground-level image.

9. The system of claim 8, the non-transitory memory further comprising instructions to cause the system to:
obtain geolocation data for the overhead image and the ground-level image,
wherein the geolocation data allows each pixel in each of the overhead image and the ground-level image to be linked to a specific geographic position;
incorporate environmental impact data and sustainability metrics into the final render image,
wherein the environmental impact data and sustainability metrics relate to reducing emissions of greenhouse gasses and are used to determine a location of an EVSE to mitigate climate change;
determine, based on the geolocation data and a location of an EVSE, a size and orientation for an image of an EVSE to be included in the final render image;
generate an image of an EVSE that has the determined size and orientation; and
cause the final render image to include the image of the EVSE having the determined size and orientation.

10. The system of claim 8, the non-transitory memory further comprising instructions to cause the system to:
obtain images of EVSE and images of vehicles; and
process the images of EVSE and the images of vehicles with the second ML model,
wherein the second ML model embeds representations of the EVSE and/or representations of the vehicles into the final render image.

11. The system of claim 8, the non-transitory memory further comprising instructions to cause the system to:
receive, from a user, a selection of a representation of the EVSE that is embedded into the final render image.

12. The system of claim 8, the non-transitory memory further comprising instructions to cause the system to:
process, with a third ML model, the final render image and a reference image of a parking area in which an EVSE has been installed;
quantify a quality of the final render image by assigning a value to a predetermined metric; and
improve the second ML model based on the value assigned to the predetermined metric.

13. The system of claim 8, the non-transitory memory further comprising instructions to cause the system to:
obtain from a user a text-based prompt;
process the text-based prompt using the second ML model; and
generate the final render image by the second ML model based in part on the text-based prompt.

14. A non-transitory, computer-readable storage medium comprising instructions recorded thereon, wherein the instructions, when executed by at least one data processor of a system, cause the system to:
obtain a set of images of a parking area, the set of images comprising:
an overhead image taken from an overhead perspective of the parking area, and
a ground-level image taken from a perspective at or near ground level;
obtain location data corresponding to an intended location of electric vehicle service equipment (EVSE) within the parking area,
wherein the location data corresponds to a location on the overhead image of the parking area;
generate an intermediate image by using a first machine learning (ML) model; and
generate a final render image of the parking area by using a second ML model,
wherein the second ML model processes the location data, the overhead image, the ground-level image, and the intermediate image, and
wherein the final render image is a depiction of the EVSE incorporated into the parking area shown in the ground-level image.

15. The non-transitory, computer-readable storage medium of claim 14, the instructions recorded thereon further comprising instructions that cause the system to:
obtain geolocation data for the overhead image and the ground-level image,
wherein the geolocation data allows each pixel in each of the overhead image and the ground-level image to be linked to a specific geographic position;
determine, based on the geolocation data, a size and orientation for a representation of the EVSE to be included in the final render image;
generate an image of the EVSE that has the determined size and orientation; and
cause the final render image to include the image of the EVSE having the determined size and orientation.

16. The non-transitory, computer-readable storage medium of claim 14, the instructions recorded thereon further comprising instructions that cause the system to:
obtain images of EVSE and images of vehicles; and
process the images of EVSE and the images of vehicles with the second ML model,
wherein the second ML model embeds representations of the EVSE and/or representations of the vehicles into the final render image.

17. The non-transitory, computer-readable storage medium of claim 14, the instructions recorded thereon further comprising instructions that cause the system to:
receive, from a user, a selection of a representation of the EVSE that is embedded into the final render image.

18. The non-transitory, computer-readable storage medium of claim 14, in which the second ML model comprises:
a diffusion model,
a convolutional neural network (CNN),
a generative adversarial network (GAN),
a variational autoencoder (VAE),
a vision-language model (VLM), or
a support vector machine (SVM).

19. The non-transitory, computer-readable storage medium of claim 14, the instructions recorded thereon further comprising instructions that cause the system to:
process, with a third ML model, the final render image and a reference image of a parking area in which an EVSE has been installed;
quantify a quality of the final render image by assigning a value to a predetermined metric; and
improve the second ML model based on the value assigned to the predetermined metric.

20. The non-transitory, computer-readable storage medium of claim 14, the instructions recorded thereon further comprising instructions that cause the system to:
obtain from a user a text-based prompt;
process the text-based prompt using the second ML model; and
generate the final render image by the second ML model based on the text-based prompt.
